(19) United States
(12) Patent Application Publication
(10) Pub. No.: US 2016/0007163 A1
(43) Pub. Date: Jan. 7, 2016

(54) METHOD AND SYSTEM FOR LOCALIZATION OF OBJETS IN WIRELESS SPONTANEOUS NETWORK

(71) Applicant: VOLANTIC AB, Skellefteå (SE)

(72) Inventors: Thomas Malm, Skellefteå (SE); Adrian Jakobsson, Ursviken (SE)

(73) Assignee: Volantic AB, Skellefteå (SE)

(21) Appl. No.: 14/771,423

(22) PCT Filed: Feb. 26, 2014
(86) PCT No.: PCT/SE2014/050235

§ 371 Date: Aug. 28, 2015

(30) Foreign Application Priority Data
Feb. 28, 2013 (SE) 1350227-3

(51) Int. Cl. H04W 4/02; H04W 4/00; H04W 76/02; G01S 5/00

(52) U.S. Cl. CPC H04W 4/025; G01S 5/0018; H04W 4/008; H04W 76/021

(57) ABSTRACT

The invention relates to a method and a system for the localization of objects which carry a passive target unit PSTR (10) with a unique identity. The method comprises of the following steps: a search unit LAASR (20) is arranged; the search unit LAASR (20) and the target unit PSTR (10) form a spontaneous network; the search unit LAASR (20) generates an electronic message containing geographical position; a server unit SAS (40) is arranged; at spontaneous contact between the search unit LAASR (20) and the passive target unit PSTR (10) a message (3) is generated; from the target unit PSTR (10), associated data is added to the message (3), including the geographical position (X1, X2); the message (3) is transmitted from the search unit LAASR (20) to the server unit SAS (40). The contact between the search unit LAASR (20) and target unit PSTR (10) takes place by one-way wireless short-range data communication, whereby the unique identity of the target unit PSTR (10) and the discoverability message are recorded by the search unit LAASR (20) and is forwarded through a mobile telecommunication network.

### TECHNICAL FIELD OF THE INVENTION

The present invention concerns to a method for the localization of objects in wireless spontaneous networks according to the introduction to claim 1 and a system for localization of object according to the introduction to claim 9. The invention also concerns to a method where usage of a mobile phone which is of the type that supports handling and usage of software or application programs known as “apps”, also concerning an application program for a mobile phone known as “app” according to claim 14.

### BACKGROUND TO THE INVENTION

The localization of objects such as, for example, stolen goods; missing persons and animals; persons, goods or vehicles for which the police are searching and that are in motion or stationary, etc., is a technical area that has developed in parallel with the development of an improved GPS system (where “GPS” is an abbreviation for “global positioning system”), refined radio and mobile technology and introduction of smart mobile phones (Smartphones). Modern technology makes possible, among other operations, the rapid and efficient localization of an object if this has been equipped with a suitably designed mobile telecommunication unit.

In order to transfer information about the location, position, status and possibly other information about an object, conventional localization systems use the global positioning system, GPS, and conventional mobile telephone technology, GSM, 3G and 4G.

The position and location of the object in question can be transmitted to its owner, relatives, authorities, etc., by the determination of its position and the placing of a telephone call over the mobile telephone network. One disadvantage of known systems is that they require a subscription with a third party operator, such as a mobile telephone operator that owns the mobile telephone network and that receives and processes the signals. This in turn leads to the systems becoming unnecessarily expensive and complicated, and to all extents and purposes available solely for a few stakeholders and authorities.

The Involvement of a third party and the insight and supervision that such parties obtain into one's own operations may in certain cases lead to a reluctance of certain stakeholders to use such conventional localization systems.

Since known localization systems use conventional mobile communication systems such as GSM, 3G and 4G for the wireless transfer of information, these systems have the disadvantage that they require relatively high transmitter powers, and this in turn means that the systems consume relatively large amounts of energy, and have a limited operating period. The target units of known localization systems are provided with timers, with which it is possible for them to work intermittently, in order to reduce the of consumption of energy. The timer enables the unit to be switched on and switched off at suitable intervals.

The Purpose of the Invention

The purpose of the present invention is thus to achieve a method and a system for the localization of objects in wireless spontaneous networks that make it possible to simplify the technology and provide it more cheaply.

In particular, a system is aspired to that makes it possible to search efficiently for objects in formed wireless spontaneous networks with the aid of the cheap short-range technology, in particular Bluetooth, Low Energy Bluetooth and WiFi and subscription with third party operator. In this way not only to hold the investment costs at a low level, but also to obtain a system that not only consumes very little power but also provides a long operating period.

### SUMMARY OF THE INVENTION

These both purposes of the invention are achieved by the method and system which describes the properties and characteristics that are specified by claim 1 and 9, respectively.

According to one aspect of the present invention, a method for the localization of objects in wireless spontaneous networks is achieved where the said objects incorporate a passive target radio unit (Passive Sending Target Radio PSTR). The spontaneous network is formed during the use of at least one search unit (Location Aware Active Search Radio LAASR) for contact through wireless short-range communication not only with the target unit PSTR but also through mobile radio communication to a search application server SAS designed to administrate search tasks to and from the spontaneous network through short-range communication or other mobile communication. Each passive target radio unit PSTR is configured so it is and continues to be in a “discoverable state” according to the current used radio communication protocol such as Bluetooth, WiFi or other pre-defined radio protocol that supports this feature. Within the scope of this feature, a unique discoverable identity is made available such as a MAC address, a Radio-Node-ID address, RNID address or similar. At contact with any of the search units, this identity will be registered, spontaneously and in single direction without any explicit request from the search unit. A message is generated in the search unit LAASR containing its own geographic position and the identified target radio unit's unique identity. This gathered data is transported back via the mobile network to the search application server SAS via LAASR. Since the communication between the target radio unit PSTR and the search unit LAASR is achieved through a one-direction short-range data communication without any data exchange between the units, can a very cheap, efficient and secure system be established.

### BRIEF DESCRIPTION OF THE DRAWINGS

FIG. 1 shows schematically the units that are components of the system for the localization of objects according to the present invention.

FIG. 2 shows a typical search process with the components involved according to the invention.

FIG. 3 shows a block diagram for a target unit PSTR, a component of the system according to the invention.

FIG. 4 shows a functional diagram for the target unit PSTR according to FIG. 3.

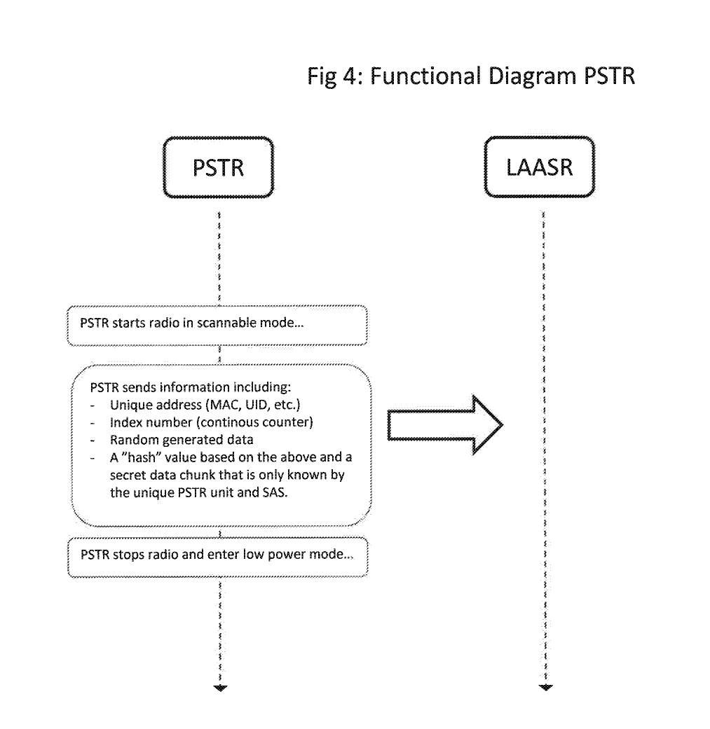

FIG. 5 shows a block diagram for a proprietary search unit LAASR, a component of the system according to the invention.

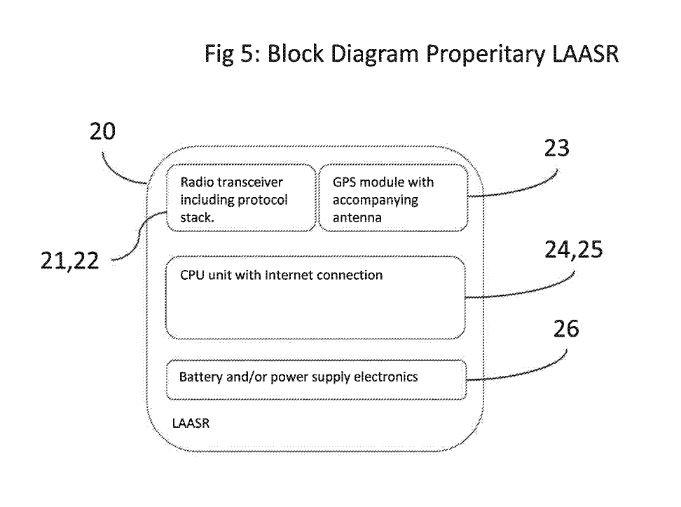

FIG. 6 shows a block diagram for a mobile phone as a search unit LAASR, a component of the system according to the invention.

FIG. 7 shows a model for how the generated messages are transported through the system.

FIG. 8 shows a definition of the messages generated in the system.

FIG. 9 shows an example scenario on how the invention works.

### DETAILED DESCRIPTION OF THE INVENTION

A system is described below that uses any suitable radio protocol such as Bluetooth, Low Energy Bluetooth, WiFi or any similar protocol for wireless short-range data communication and the establishment of a spontaneous wireless one way communication to identify a unique identification of a target radio unit. One-way communication relates to such information transmission that is in one direction, i.e. receiving unit “sniffs” necessary information about a transmitting unit or node without possible establishment, through defined radio communication protocol, specified log-in/paring procedure. No connected data communication is ever established between the units. Since the connection between the search and target unit is established without data exchange and only with limited amount of information data transmitted through one-way communication from the digitally active radio units also called nodes, a simple, energy efficient and cost effective system is achieved. The system is described through the usage of known radio communication protocols but could also be achieved through proprietary radio communication protocols as long as basic identification procedures are supported. The system can be used within a number of different environments and regions where vehicles, mobile units, people or other objects are located in different situations. The target units or nodes are entirely autonomous and are activated at final assembly and manufacturing. The nodes communicate periodically to the surrounding environment their discoverability by broadcasting a radio signal, a “discoverability message”, containing their unique identity. This message containing the unique identity is generated through a defined security algorithm that is unique for each node. The identity message is protected through a code that can be loaded into the unit when the unit is manufactured.

The receiving unit or the search unit can consist of a communication unit in form of a mobile phone, a computer or PC containing an application such as an “app” to identify and interpret the sent message, “discoverability message”, from the target units. A modern mobile phone has the big advantage of, in its standard configuration, containing the necessary software that incorporates message handling and connection program.

The application in the search unit is also responsible for, at recognition of “discoverability message”, associating a geographic position to the discovered target unit. The geographical position is obtained through the receiver's available positioning system such as GPS, AGPS or other positioning mechanism.

The search unit is also responsible for further transport of the target unit unique session data through the mobile communication network to the server unit which executes the necessary authentication of the target units identity and stores, processes and makes available this information for further processing, usage and visualization on a digital map.

The search unit receives data from the target unit through a suitable protocol for short-range radio communication such as Bluetooth, Low Energy Bluetooth, WiFi, various generations of mobile telephony systems or other standardized or proprietary radio protocol. The systems overlying communication protocol is constructed based on a limited data amount to avoid excessive communication and thereby limit the energy consumption in the target unit.

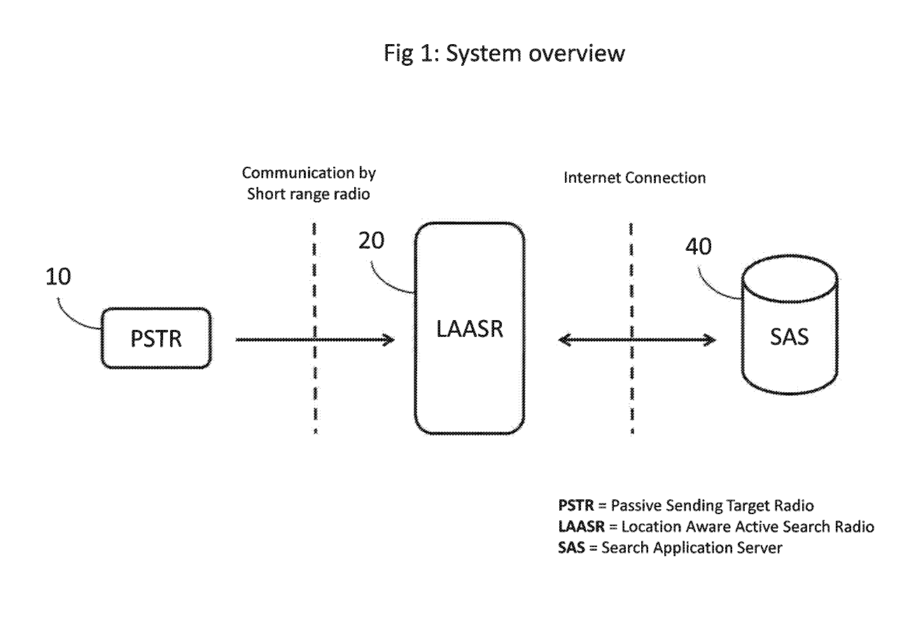

The system consists principally of three types of unit as illustrated in FIG. 1.

Target unit 10, “Passive Sending Target Radio”, PSTR

Search unit 20, “Location Aware Active Search Radio”, LAASR

Server unit 40, “Search Application Server”, SAS

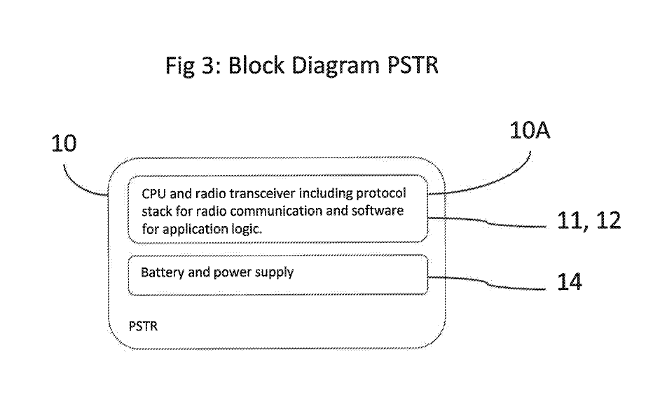

FIG. 3 shows the target unit PSTR 10 in more detail. The target unit PSTR 10 is used to label an object. The target unit PSTR 10 demonstrates low consumption of power and it is to operate for at least 1 year. It furthermore demonstrates a range of radio communication of at least 10 meters. In order to function in the manner intended, the target unit PSTR 10 comprises the following parts: Radio transceiver module 11 (a radio module) that includes a CPU and protocol stack 12. Battery with its associated power supply electronic circuits 14.

The Target unit PSTR 10 radio module 11 is programmed in such a manner that it periodically sends a secured “discoverability message” and is thereby equipped with necessary means to wirelessly send short-range data for instance through a Bluetooth transmitter or similar unlicensed RF-communication frequency. The security code and the periodicity of the transmitted “discoverability message” is defined in manufacturing process of the target unit through unique identification data that incorporates a secret algorithm which is static and cannot be modified, unless the unit is connected physically to a special preparation application for calibration. The security coding enables a unique identification that can be authenticated in the related server unit SAS 40 which contains verification organ 40A for the purpose, while corresponding code with the mentioned unique identification data as the target unit PSTR 10, in advanced is stored in the server unit SAS.

The target unit PSTR is a passive unit that due to security reasons cannot be contacted by the search unit LAASR 20, i.e. the communication between mentioned units is in one direction. A distinctive characteristic in the present invention is thereby the fact that no bidirectional paring or authentication is performed between the target unit and the search unit during a search procedure. The one-way communication procedure ensures that the target unit PSTR cannot be manipulated during operation for the purpose of putting the system out of operation.

The security coding of the “discoverability message” ensures that no “pirated” units could be added into the system for the purpose of confusing the identification of authentic and unique target units PSTR 10. The target unit is constructed in a way that it can easily be used to label different objects by applying it to the objects. Depending on the intended application area the target PSTR 10 unit can be formed in various ways, primarily with regards to its format and lifespan. In some circumstances it is suitable to attach the target unit PSTR 10 to an object already at manufacturing of that object. This could apply to theft-prone objects such as bicycles, portable computers, equipment and vehicles. A characteristic in common for all sold target units PSTR 10 will be that the owner of each unit will acquire an object number (obj-number) in the form of a registration certificate for his/hers unit which is intended to be used during search and localization of the target unit PSTR 10.

FIG. 1 shows a proprietary variant of the search unit LAASR 20 in more detail and as defined it contains mainly of the following parts:

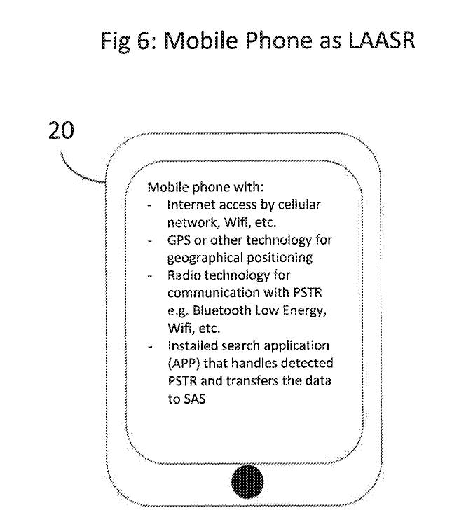

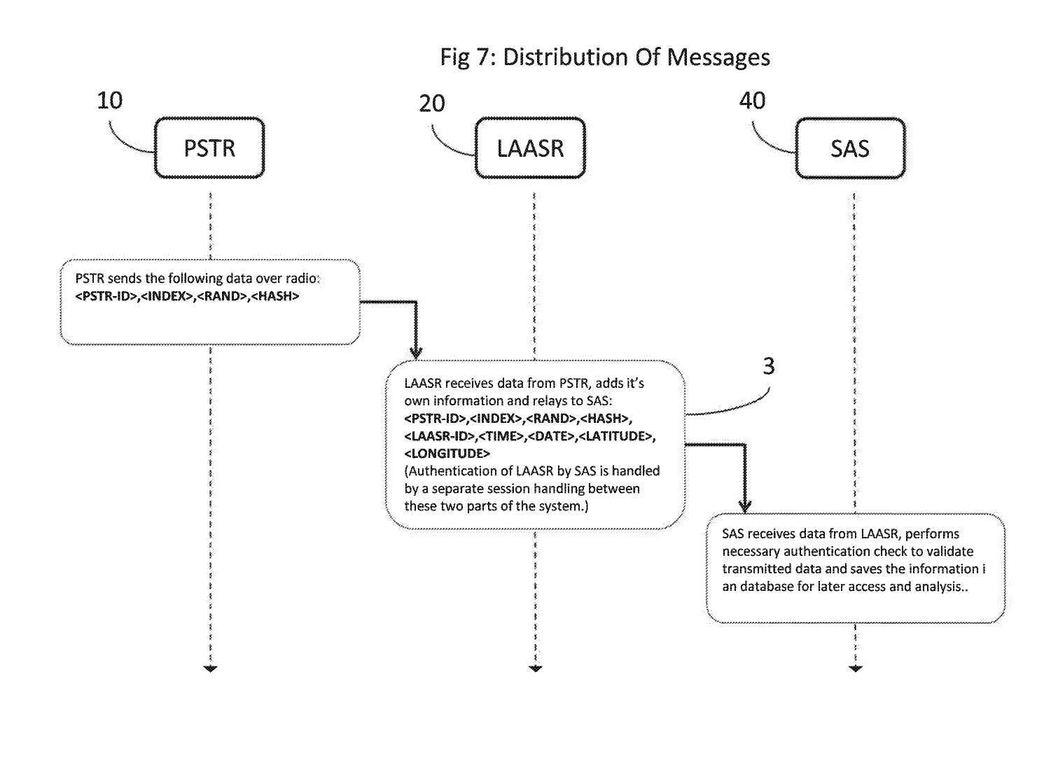

Radio transceiver modules 21 (radio modules) with corresponding protocol stack 22.
GPS-module 23 or other positioning mechanism for localization.
CPU unit 24 with corresponding Internet connection unit 25 and for reporting back to the server unit SAS 40 either through wired or mobile communication system.
Power supply electronics 26
   FIG. 6 shows in more detail a mobile phone or equivalent portable computer based client unit as a variant of the search unit LAASR 20 with the following essential requirements on inherent features to be used as an LAASR:
Appropriate generation of mobile technology which allows data transmission through mobile internet.
GPS-module 23 or other positioning mechanism for localization.
Radio technology for short distance data communication with corresponding peripheral components or network such as WiFi, Bluetooth, Low Energy Bluetooth or other.
The ability to carry and execute an application for search, Search Application. As illustrated in FIG. 7 the search unit LAASR 20 listens for “discoverability message” from target units PSTR 10. The search unit LAASR 20 listens primarily for possible “discoverability messages” from target units in range.

When recognizing a “discoverability message” from a target unit PSTR 10 a data package 3 is generated in which the search unit adds its own position retrieved from its GPS module (or other positioning mechanism) and the target units PSTR 10 identification code (Hardware ID; MAC, IMEI etc).

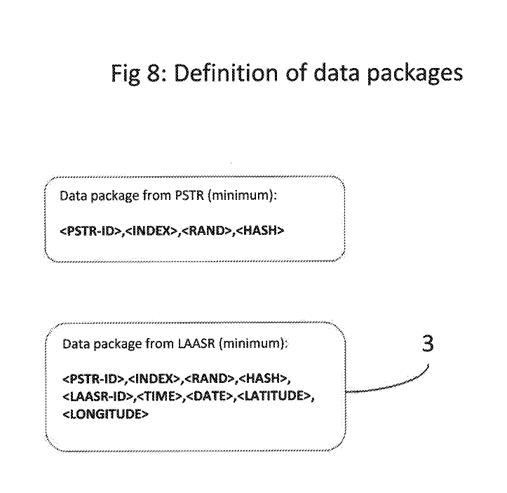

FIG. 8 shows an example on such a message, a position package 3.
The position package 3 will either be sent directly back through the mobile Internet or through any other suitable communication method such as SMS (“Short Message Service”), MMS (“Multimedia Messaging Service”) or an e-mail message to the overlying server unit SAS 40 of the system.

Alternatively, suitable number of position packages 3 could be gathered, stored and sent on less often occasions. The server unit SAS 40 hereby acquires information indicating that the searched target units PSTR 10 is roughly positioned and also acquires identification on that specific search unit LAASR 20 which has registered the valid target unit PSTR 10. The search application could preferably be deployed in several search units thereby a continuous stream of position packages 3, valid for geographically spread PSTR 10, be provided to and be accessible in the server unit SAS 40. Moreover the search unit LAASR 20 is designed to be remotely updated (app update) and also support “anchoring” of target units PSTR 10, i.e. surveillance and control of one or several specific target units to indicate when the target unit PSTR 10 has reached an out of radio signal distance. The anchoring concept is when radio contact is lost with the target unit PSTR 10, the search unit LAASR 20 generates a message that is transported back to the server unit 40.

The proprietary variant of the search unit LAASR 20, i.e. search units with pre defined restrictions in terms of usage, modification etc., could appropriately be distributed to vehicles with periodic routes in order to build an infrastructure for search of target units PSTR 10. The mobile phone based variant of the search unit is enabled by a search application, an app, which is installed on a phone by a user for the purpose of explicitly participate in a security system or indirectly participate in activities that are based on a reward system when a target unit is found. The reward system will be based on the gathered information in the server unit SAS 40 about the associated information on the search unit LAASR 20 in each position package 3 about the discovered target unit PSTR 10.

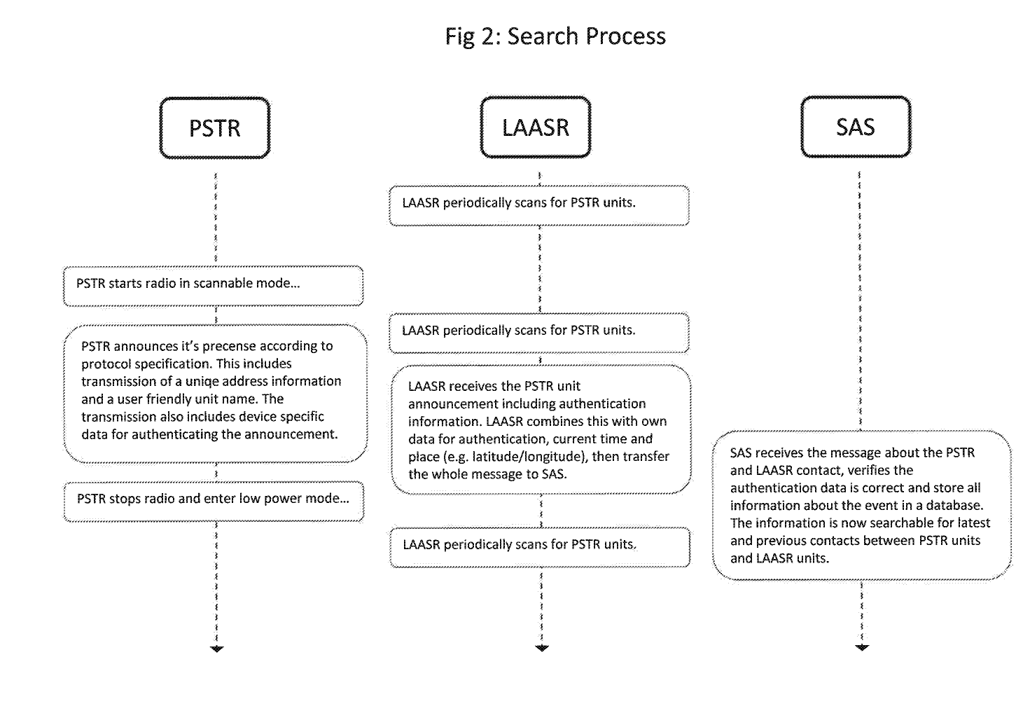

FIG. 2 illustrates the search process in more detail and as stated the target unit PSTR 10 (PSTR x) periodically transmits the “discoverability message” through an appropriate short-range data communication (radio communication). The search units LAASR 20 discover these messages whenever these units are in range.

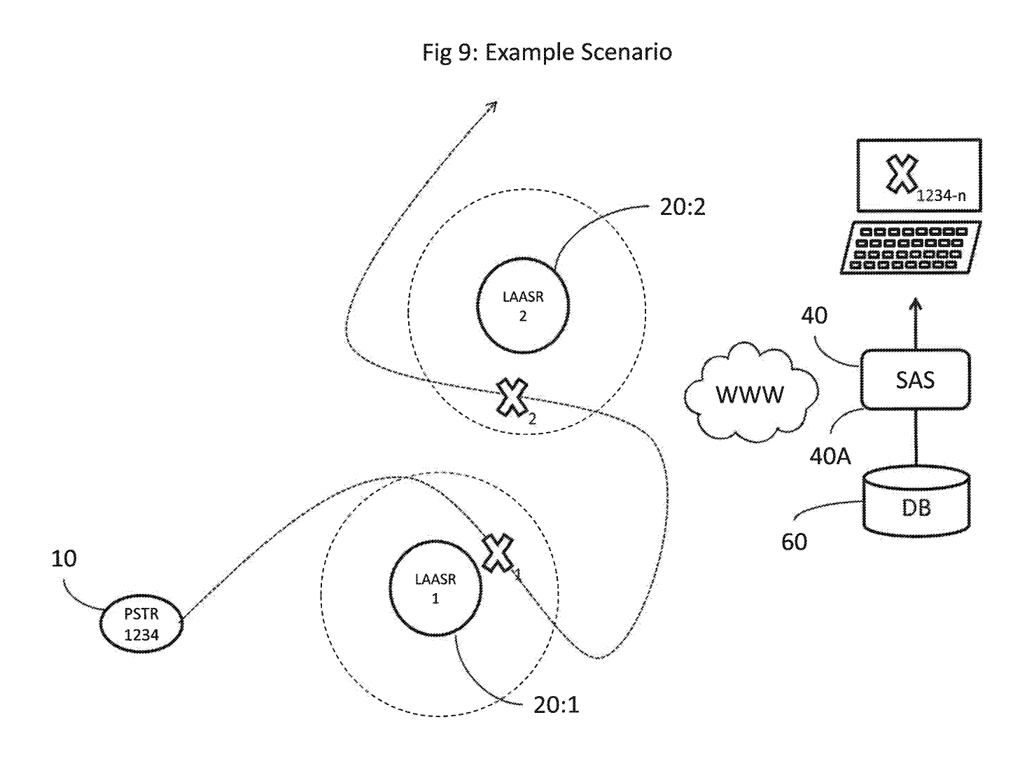

With reference to FIG. 9 an example is illustrated where the target unit PSTR 10 is detected by two separate first and second search units LAASR 20:1 resp. LAASR 20:2 and further how the information on spontaneously established contact between the units generates localization information which is transferred through radio communication and stored in the server unit SAS 40.

A target unit PSTR 10 with the identification number 1234 is attached to an object that has been stolen and is moving along the dash-dotted contour line that stretches from the target unit and is ended with an arrow. Along this line the target unit PSTR 10 will first come within the range of the first search unit LAASR 20:1, this will happen when PSTR 10 is within the radio bubble that is illustrated by the dashed circle around both search units LAASR 20:1 resp. 20:2. At this stage the radio signals from the target unit PSTR 10 are within the range for the search unit LAASR 20:1. This spontaneous connection is illustrated with X1.

At the specified connection the target unit PSTR 10 sends a message that for example contains the following data 1234,000012FE, FE12ABBB, 112A5CEFE12F982FA2 where 1234 represents the identification of the target unit PSTR 10, 000012FE is an index number for a counter that continuously counts up in 1 sec intervals during the pre-defined lifetime of the target unit PSTR 10, FE12ABBB is a randomly chosen data sequence, 112A5CEFE12F982FA2 a so called hash-value that is calculated based on all previous values together with the secret code, identification data that is partly stored in the current target unit PSTR 10, 1234, and partly stored on the server unit SAS 40. The first search unit LAASR 20:2 will receive above-described message, adding the information about its own identity, time and date when the meeting X1 took place plus information that contains the geographic data (latitude and longitude) for the meeting. All this information is put together as a message and sent through the mobile Internet WWW to the server unit SAS 40 for storage in the database DB 60. For this purpose the target unit PSTR 10 contains a production means 10A that based on a counter built in the unit, generates a data object that is attached to the “discoverability message” that is received by the search unit LAASR 20.

The search unit PSTR 10 continues to move along the dashed line and will eventually come in contact with the other search unit LAASR 20:2. At the X2 point, the target unit PSTR 10 is close enough so its radio signals containing the “discoverability message” reaches the other search unit LAASR 20:2.

At this point the target unit PSTR 10 will send a message that could contain the following data 1234,00001302,4398F1AD,315B52AF342F0C11F3. As described above, the specified data contains the following information; The identification number of the target unit PSTR 10, an index number (note that the value this time is higher than the previous message), a randomly chosen data sequence and a hash-value based on the message data and the secret code, identification data that is stored in the target unit PSTR 10 and in the server unit SAS 40. The other search unit LAASR 20:2 receives the above described data, adds information about its own identity, time, date and geographic location for the meeting and sends this message through the mobile internet to the server unit SAS 40 for further storage in the database DB 60. All data with regards to possible following meeting locations, X1-Xn, will be verified by the server unit SAS 40 by calculating the hash-value in the same manner as the target unit PSTR 10 has done before the transmission of the message through the short-distance data communication. That is, for the point labeled X1, the server unit SAS 40 handles the values 1234, 000012FE, FE12ABBB and the secret code for the target unit PSTR 10 that is stored in the server unit SAS 40. Thereby the calculated value is compared by the value that the target unit PSTR 10 has transmitted (i.e. 112A5CEFE12F982FA2), if the value that was calculated by the server unit SAS 40 equals with the value that was transmitted by the target unit PSTR 10 then the message is considered valid, if the two values are not equal at comparison then the message is considered invalid. The validity of the meeting place X2, and the following meeting places Xn that are not illustrated, are tied to the meeting place X1 by the means of an index number that is bigger than the X1 to verify the validity of these messages.

The purpose of this procedure is to avoid so called “replay attacks” where a counterfeit target unit PSTR 10 could replay radio messages that are gathered during earlier sessions. The server unit SAS 40 will continuously keep track of all the index numbers for each individual target unit PSTR 10 that is registered in the system to guaranty this functionality.

Further, different type of services could be built by using all the meeting places. For example, it could be possible to show a range of meeting places “X” on a digital map, which are labeled with the identification number and time/date of the target unit PSTR 10 for that meeting place according to the description in FIG. 9. It is also possible to relate each unique meeting place to one or several unique search units LAASR 20 that has been involved in the meeting.

The information could be presented for the user in any suitable way that is appropriate for positioning data. If the positioning data for example consist of area codes, it is suitable to present the data graphically in the form of a local area map.

The present invention is not limited to the above described and corresponding drawings but could be altered and modified in different ways within the scope of following patent claims describing invention purposes.

1. A method for the localisation of objects in a spontaneous wireless network in which each object bears a passive target unit PSTR with a unique electronic identity that can be registered, and which method includes the following steps:
a search unit LAASR is arranged;
the search unit LAASR and the target unit PSTR are designed for mutual contact and the formation of spontaneous networks through wireless communication;
the search unit LAASR is equipped with means for the generation of an electronic message and the determination of its geographical position;
a server unit SAS with an associated database DB is arranged;
the search unit LAASR is arranged for wireless communication with the server unit;
in the event of spontaneous contact between the search unit LAASR and the passive target unit PSTR a message is generated by the contacting search unit;
based on the unique identity of the relevant target unit PSTR, associated data from the contacting search unit is added to the message, including the geographical position of the search unit LAASR at the time of contact;
the message that is generated when contact is made is addressed and transmitted from the search unit LAASR to the server unit SAS, characterised in that the spontaneous contact between the search unit LAASR and the passive target unit PSTR takes place by one-way wireless short-range data communication, whereby the unique identity of the target unit PSTR and the discoverability message are recorded by the search unit LAASR without return data exchange with the target unit PSTR, and that the message from the search unit LAASR to the server unit SAS is forwarded through a mobile telecommunication network.

2. The method according to claim 1, whereby the spontaneous contact between the search unit LAASR and the passive target unit PSTR takes places in the absence of handshaking and pairing procedures, depending on the communication protocol selected.

3. The method according to claim 1, whereby the message that is generated in the event of contact is addressed and transmitted from the search unit LAASR in order to be subsequently registered in the server unit together with the unique identity of the search unit LAASR in order to achieve traceability and provide information about the search unit in which the message was generated.

4. The method according to claim 1, whereby identification and check of the target unit PSTR is carried out through the unique identity of the target unit, which has been forwarded in the message, is compared in the server unit SAS with a register of identities that has been stored in advance in the database DB.

5. The method according to claim 1, whereby the target unit PSTR provides supplementary identity data based on an index number that has been set based on the predetermined lifetime of the target unit PSTR, which index number, for identification and check of the target unit that has been contacted, is compared in the server unit SAS with corresponding index numbers that have been stored in advance in the database DB.

6. The method according to claim 1, whereby the search unit LAASR is arranged for the “anchoring” of one or several specific target units PSTR and that, in the event of loss of radio contact with a target unit PSTR with a specified identity, a message is generated in the search unit LAASR that is addressed and transmitted to the server unit.

7. The method according to claim 1, whereby the search unit LAASR is arranged on some displaceable object such as a person, a vehicle that takes regularly repeated routes, a rental car, a postal vehicle or similar distribution vehicle, or a bus, a tram or a train in order to form an infrastructure that can search for the target unit PSTR.

8. The method according to claim 7, whereby any one of the following communication units is used as search unit LAASR: a mobile telephone, a computer or PC that contains an application such as an “app” in order to identify and interpret spontaneously transmitted “discoverability messages” from a target unit PSTR.

9. A system for the localisation of objects in spontaneous wireless networks comprising;
one or several passive target units PSTR each one of which has a unique electronic identity that can be registered and is intended to be arranged at a relevant object;
a passive search unit LAASR in which is included a CPU unit for the generation of a message and a GPS module for the generation of information about the geographical position of the search unit,
a server unit SAS with an associated database DB and which server unit is designed for wireless communication with the search unit LAASR;
that each passive target unit PSTR and each search unit LAASR comprise a radio module that allows spontaneous short-range communication between the units; and that in the event of spontaneous contact between a search unit LAASR and a target unit PSTR a message is generated by the contacting search unit in which, based on the unique identity of the target unit PSTR, associated data from the contacting search unit LAASR is added to the message, including the geographical position (X1, X2) of the search unit at the time of contact; where the message that is generated on contact is addressed and transmitted from the search unit LAASR to the server unit SAS, characterised in that the search unit LAASR and the passive target unit PSTR comprise means for one-way short-range data communication from the target unit PSTR to the search unit LAASR, whereby the unique identity and discoverability message of the target unit are registered by the search unit LAASR in the absence of return data exchange with the target unit, that the search unit LAASR comprises a radio module that permits communication between the units over a mobile telecommunication network and in that the said message with information about the unique identity of the target unit is forwarded from the search unit LAASR to the server unit SAS over a mobile telecommunication network.

10. The system according to claim 9, whereby the server unit SAS comprises a verification means in order to check that the unique identity of the target unit PSTR, which is forwarded in the message, is in accordance with an identity that has been stored in advance in the database DB that is associated with the server unit SAS.

11. The system according to claim 9, whereby the target unit PSTR comprises a production means to produce a data object that is added to the message that is transmitted from the search unit LAASR, which data object is given data that has been set based on the pre-determined lifetime of the target unit PSTR, and in that the server unit SAS comprises verification means to check that the data object of the target unit PSTR that has been set by the production means and that is forwarded in the message is in accordance with values that have been previously stored in the database at the server unit SAS.

12. The system according to claim 9, whereby the search unit LAASR comprises not only means for short-range wireless data communication but also means for the wireless data transfer over a mobile telecommunications network.

13. The use of a mobile telephone with software in the form of an application, an “app”, to identify and interpret spontaneously transmitted “discoverability messages” from target units, using one-way short-range wireless data communication and in the absence of return data exchange from the mobile telephone to a target unit.

14. An application program including software in the form of what is known as an “app”, intended to be used in a mobile telephone, which program demonstrates the ability
to identify and interpret spontaneously transmitted “discoverability messages” from a target unit PSTR, using one-way short-range data communication and in the absence of return data exchange from the mobile telephone to the target unit, and
to be attached associated data based on the unique identity of the target unit PSTR to a message including the geographical position of the mobile telephone when the contact was made; where the message that was generates when the contact was made is addressed and transmitted from the mobile telephone to a server unit SAS over a mobile telecommunication network.
